(19) United States
(12) Patent Application Publication
(10) Pub. No.: US 2009/0305210 A1
(43) Pub. Date: Dec. 10, 2009

(54) System For Robotic Surgery Training

(76) Inventors: Khurshid Guru, East Amherst, NY (US); Thenkurussi Kesavadas, Clarence Center, NY (US); Govindarajan Srimathveeravalli, Buffalo, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/402,303

(22) Filed: Mar. 11, 2009

Related U.S. Application Data
(60) Provisional application No. 61/035,594, filed on Mar. 11, 2008.

(51) Int. Cl. G09B 23/28

(52) U.S. Cl. 434/262

(57) ABSTRACT

A system according to the invention may include a frame, a computer, a display, and two input devices. The frame may be adjustable, may be made from a lightweight material, and may fold for easier portability. The display and the computer may be in communication with each other and each may be attached to the frame. The display may be a binocular display, or may be a touchscreen display. Additional displays may be used. Two input devices may be used to simulate the master console of a surgical robot. The input devices may be articulated armature devices suitable for providing 3D input. The input devices may be attached to the frame in an “upside-down” configuration wherein a base of each input device is affixed to the frame such that a first joint of an arm is below the base. The input devices may be in communication with the computer and may provide positional signals to the computer. The positional signals may correspond to a position of an arm of each input device.

### CROSS-REFERENCE TO RELATED APPLICATION

This application claims the benefit of priority to U.S. provisional patent application Ser. No. 61/035,594, filed on Mar. 11, 2008, now pending, which application is hereby incorporated by reference.

### FIELD OF THE INVENTION

The present invention relates generally to robotic surgery simulators and in particular, to a system and method for simulating the kinematics of a surgical robot.

### BACKGROUND OF THE INVENTION

Robotic surgery is becoming increasingly popular due to its many benefits over traditional open surgeries, including quicker recovery time, less pain, and less scarring. A robotic surgery system, such as the da Vinci® Surgical System (“dVSS”) from Intuitive Surgical, Inc., typically consists of two main components; master console and a slave robot. A surgeon provides input through a manipulator of the master console which, in turn, controls a slave robot to perform the necessary motions at the patient.

Many surgeons are reluctant to switch to surgical robots, however, because of the differences in the skill set of the surgeon. For example, in traditional open surgeries and laparoscopic surgical procedures, the forces encountered by the tools used in the surgery are felt by the surgeon. In contrast, most robotic master consoles do not provide any force feedback to the surgeon. Generations of surgeons have been trained to perform surgical procedures using tactile sensation as a key sensory input, and performing a procedure without this sense is seen as a paradigm shift requiring extensive re-training before a surgeon may be allowed to perform procedures using robotic systems.

The acquisition costs for surgical robots is high—as high as several million dollars. Because of the expense of the equipment, it is most cost effective to devote as much of the surgical robot's time to performance of actual procedures. Therefore, the availability of such expensive equipment for training is usually low.

Accordingly, there exists a need for a less expensive system for training surgeons in robotic procedures. Such a system should: (1) provide articulated input devices such that the kinesthetics of working with the master console is preserved; (2) provide accurate training simulations to minimize training time; (3) be compact and easy to assemble and disassemble so that the system may be transported to any location convenient for training; and (4) be inexpensive to manufacture.

### BRIEF SUMMARY OF THE INVENTION

A system according to the invention may include a frame, a computer, a display, and two input devices. The frame may be adjustable, may be made from a lightweight material, and may fold for easier portability. The display and the computer may be in communication with each other and each may be attached to the frame. The display may be a binocular display, or may be a touchscreen display. Additional displays may be used. Two input devices may be used to simulate the master console of a surgical robot. The input devices may be articulated armature devices suitable for providing 3D input. The input devices may be attached to the frame in an “upside-down” configuration wherein a base of each input device is affixed to the frame such that a first joint of an arm is below the base. The input devices may be in communication with the computer and may provide positional signals to the computer. The positional signals may correspond to a position of an arm of each input device.

The system may also include a foot-operated input such as, for example, a foot pedal, which may provide additional functions such as engaging/disengaging tools, cauterization, cutting, turn lights on or off, changing a camera position, etc. More than one foot-operated device may be used.

The input devices may provide a position signal to the computer. The display may show a computer-generated depiction of a virtual surgical tool which may correspond to the position of the input device. The computer may be programmed to use a mathematical transform function to alter the relationship between movement of the input device in real space and movement of the virtual surgical tool in virtual space. The computer may be programmed with a Jacobian transform function to substantially mimic the relationship of a position of a manipulator of a master console to a position of a slave robot in a surgical robot. In this manner, a system according to the invention may be programmed to replicate the kinematics of a particular surgical robot.

A Robotic Surgical Simulator (RoSS) may be built according to the invention. Using commercially available input devices, computers, and displays, a system according to the invention may be built which satisfies the above-listed objectives of a surgical robot simulator. An example is provided of constructing a RoSS to simulate a dVSS.

The present invention may also be embodied as a method for simulating the kinematics of a robotic surgery system wherein a robot simulation system is provided; a robotic surgery system is provided; a first 4×4 transformation matrix may be determined; a second 4×4 transformation matrix may be determined; a simulation transformation matrix may be determined by multiplying the first and the second 4×4 transformation matrices; and the simulation transformation matrix may be used to cause a virtual surgical tool depicted on a display of the robot simulation system to respond to a positional change in an input device which substantially simulates a response of a slave robot to a positional change in a manipulator.

### DESCRIPTION OF THE DRAWINGS

For a fuller understanding of the nature and objects of the invention, reference should be made to the following detailed description taken in conjunction with the accompanying drawings, in which:

FIG. 1A is a perspective view of a system of the according to an embodiment of the present invention;

FIG. 1B is a perspective view of a binocular display which may be incorporated in an embodiment of the present invention;

FIG. 2 is a perspective view of the system of claim 1 being operated by a person;

FIG. 3A is screen view of a display showing two virtual surgical tools;

FIG. 3B is another screen view of a display showing two virtual surgical tools;

FIG. 4A is a line diagram of a dVSS manipulator;

FIG. 4B is a line diagram of a RoSS input device;

FIG. 5A is a diagram showing DH parameters;

FIG. 5B is another diagram showing DH parameters;

FIG. 6A is a graph showing the dVSS input device workspace map;

FIG. 6B is a graph showing the RoSS input device workspace map;

FIG. 6C is a graph showing the dVSS slave robot map;

FIG. 6D is a graph showing the RoSS input device workspace map;

FIG. 7A is a diagram of a dVSS slave robot;

FIG. 7B is a diagram of the end-effector of a dVSS slave robot;

FIG. 8A is a graph showing the intermediate configurations of three joints of the dVSS slave with inverse kinematics of a known RoSS input device position;

FIG. 8B is a graph showing the intermediate positions of the dVSS slave with inverse kinematics of the same RoSS input device position as in FIG. 8A;

FIG. 9 is a graph showing the limits of the RoSS input device;

FIG. 10A is a graph showing the intermediate configurations of three joints of the dVSS slave with inverse kinematics of a known RoSS input device position;

FIG. 10B is a graph showing the intermediate positions of the dVSS slave with inverse kinematics of the same RoSS input device position as in FIG. 10A; and

FIG. 11 is a method according to another embodiment of the present invention.

### DETAILED DESCRIPTION OF THE INVENTION

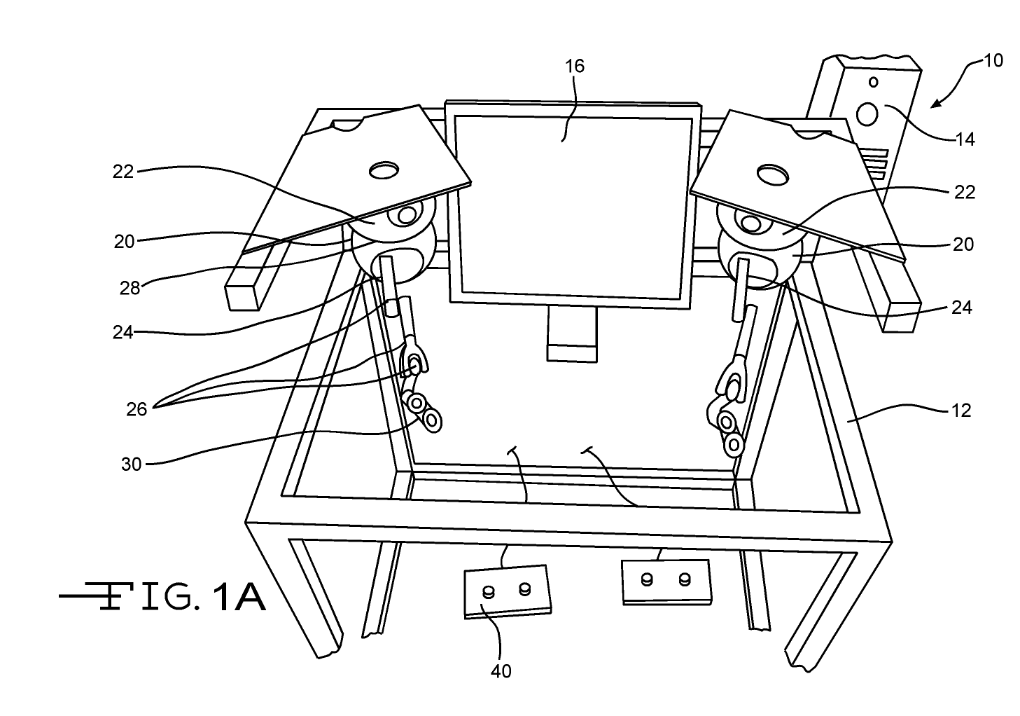

FIG. 1A depicts a system 10 according to the invention which may include a frame 12, a computer 14, a display 16, and two input devices 20 each having an end-effector 30. The frame 12 may be adjustable so that it may be more comfortable for an operator or so that it more accurately replicates the configuration of an actual surgical robot master console. The frame 12 may be made from a lightweight material and designed to fold substantially flat for easier portability. The display 16 and computer 14 may be attached to the frame 12.

The display 16 may be in communication with the computer 14. In this way, the computer 14 may provide the data shown on the display 16. The display 16 may comprise a second display. In this way, a stereoscopic image may be displayed to provide 3 dimensional (“3D”) viewing. The display 16 may be a binocular display 32; FIG. 1B shows one such binocular display 32 which may be used in a system 10 according the invention. The display 16 may be a touchscreen or may further comprise a second display which may be a touchscreen display for controlling the computer 14.

The input devices 20 may be articulated armature devices suitable for providing 3D input. Each input device 20 may comprise a base 22, an arm 24, a plurality of joints 26, and an end-effector 30. The input devices 20 may provide at least six degrees of freedom. For example, a PHANTOM Omni® device from Sensable Technologies, Inc. may be used. While the Omni® device is depicted in the drawings, any 2 link mechanism having one free rotation at the base 22, two rotations at the links and three rotations of the wrist can be used. Two input devices 20 may be used to simulate the master console of a surgical robot. The input devices 20 may be attached to the frame 12 in an “upside-down” configuration wherein the base 22 of each input device 20 is affixed to the frame 12 and the first joint 28 of the arm 24 is positioned below the base 22. The end-effector of the input device may comprise a pinch input to provide a seventh degree of freedom. The pinch input may cause a clasping motion of the jaws of a virtual surgical tool. The input devices 20 may be in communication with the computer 14, and each input device 20 may provide a position signal corresponding to a position of the arm 24 of the input device 20 to the computer 14. The position of the arm 24 may be provided by sensing the position of the joints 26.

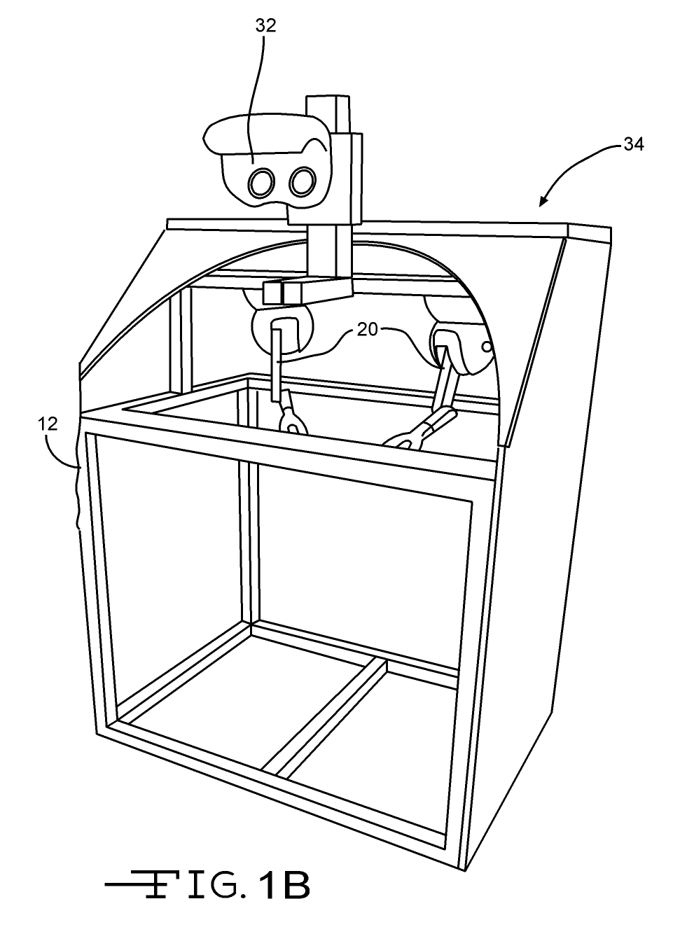

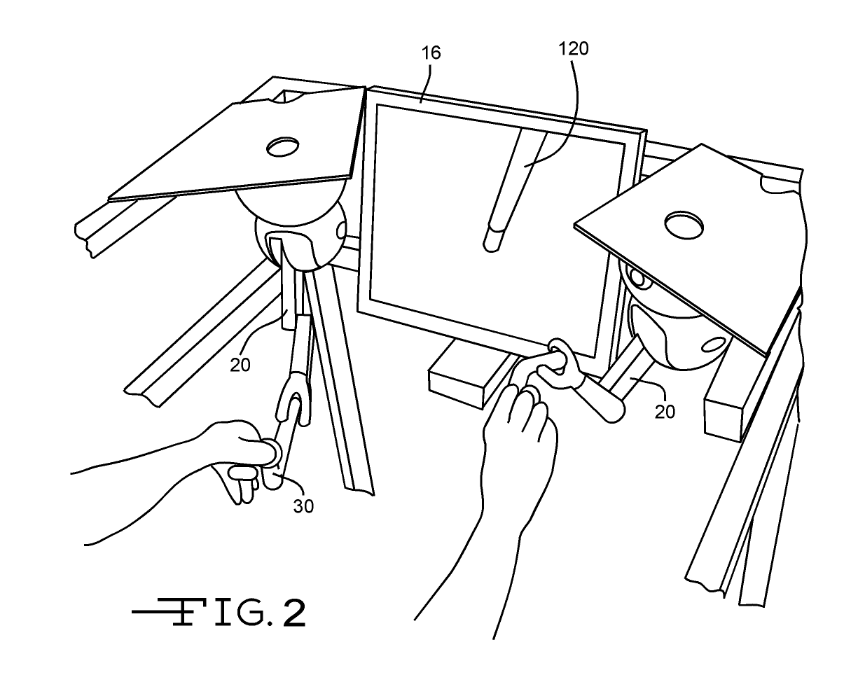

The computer 14 may be programmed to provide an image of one or more virtual surgical tools 120 to the display 16 (see, e.g., FIGS. 2, 3A, and 3B). The computer 14 may be additionally programmed to accept a position signal from at least one of the input devices 20 and transform the position signal into a position of the virtual surgical tool 120 depicted on the display 16. In this manner, changes in the position of at least one of the input devices 20 will be reflected as similar changes in the position of a virtual surgical tool 120 depicted on the display 16. The computer 14 may be programmed to use a mathematical transform function to alter the relationship between movement of the input device 20 in real space and movement of the virtual surgical tool 120 in virtual space. In this way, the virtual surgical tool 120 may move, for example, twice as fast as the input device 20, half as fast as the input device 20, the virtual surgical tool 120 may filter out a high frequency signal in the input (tremor), or any other relationship may be mapped.

The system 10 may also include a foot-operated input 40 such as, for example, a foot pedal. The foot-operated input 40 may provide functions such as engaging/disengaging tools, cauterization, cutting, turn lights on or off, changing a camera position, etc. More than one foot-operated input 40 may be used. The foot-operated input 40 may also enable additional virtual surgical tools 120 to be controlled by the input devices 20. For example, a three virtual surgical tools 120 may be controlled by two input devices 20 by using a foot-operated input 40 to selectively change the virtual surgical tools being controlled at any given time.

The computer 14 may be programmed with a Jacobian transform function wherein the Jacobian transform is calculated to substantially mimic the relationship of a position of a manipulator to a position of a slave robot in a surgical robot. In this manner, the system 10 may be programmed to replicate the kinematics of a particular surgical robot, such as, for example, a dVSS. As such, the system 10 may easily be reconfigured to mimic the feel of various surgical robots by providing a particular Jacobian transform to mimic the desired surgical robot.

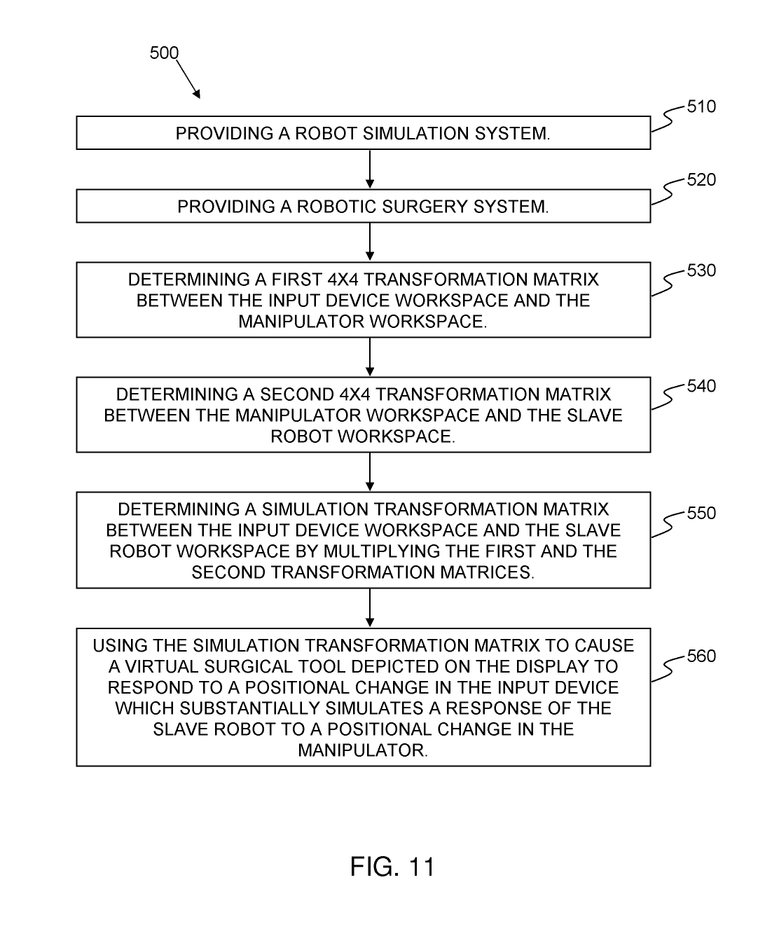

The present invention may also be embodied as a method for simulating the kinematics of a robotic surgery system 500 (see, e.g., FIG. 11). Such a method 500 may comprise the steps of providing 510 a robot simulation system. The robot simulation system may comprise a computer, a display in communication with the computer, and an input device in communication with the computer. The robot simulation system may be similar to that described above. The input device may have an input device workspace which is defined by the range of motion of the input device. The method 500 may further comprise the step of providing 520 a robotic surgery system, such as, for example, a dVSS. The robotic surgery system may comprise a master console having a manipulator. The manipulator may have a manipulator workspace defined by the range of motion of the manipulator. The robotic surgery system may further comprise a slave robot having a slave robot workspace defined by the range of motion of the slave robot.

A first 4×4 transformation matrix may be determined 530, the first 4×4 transformation matrix relating the input device workspace and the manipulator workspace. A second 4×4 transformation matrix may be determined 540, the second 4×4 transformation matrix relating the manipulator workspace and the slave workspace. A simulation transformation matrix may be determined 550 by multiplying the first 4×4 transformation matrix and the second 4×4 transformation matrix. The simulation transformation matrix may relate the input device workspace and the slave robot workspace. The simulation transformation matrix may be used 560 to cause a virtual surgical tool depicted on the display of the robot simulation system to respond to a positional change in the input device which substantially simulates a response of the slave robot to a positional change in the manipulator. In this way, the kinematics of the input device as related to the virtual surgical tool may substantially simulate the kinematics of the manipulator as related to the slave robot.

The invention is further described through example 1 below.

### Example 1

In the following example, a dVSS was simulated by a robotic surgical simulator (RoSS) system embodying the current invention.

### Kinesthetic Mapping

Kinesthetic mapping may be used to determine the transformation matrix between the simulator console workspace and the virtual slave workspace. This would help in transforming the input device 20 positions to the virtual surgical tool 120 positions which in turn will result in the virtual surgical tool motion. It may be done in two parts: (1) the workspace mapping of the simulator console 10 and surgical robot master and the workspace mapping of the surgical robot master and surgical robot slave.

### Workspace Mapping of RoSS and dVSS Input Devices Using Forward Kinematics

Forward kinematics may be used to calculate the end-effector position and orientation given the angles of all the robot joints. Sensors may be located at the joints to measure the joint angles. This may result in a unique end-effector solution in 3 dimensional space. Matrix algebra is used to describe three dimensional rotations and translations. The complexity of expressions grows exponentially with number of joints (degrees of freedom).

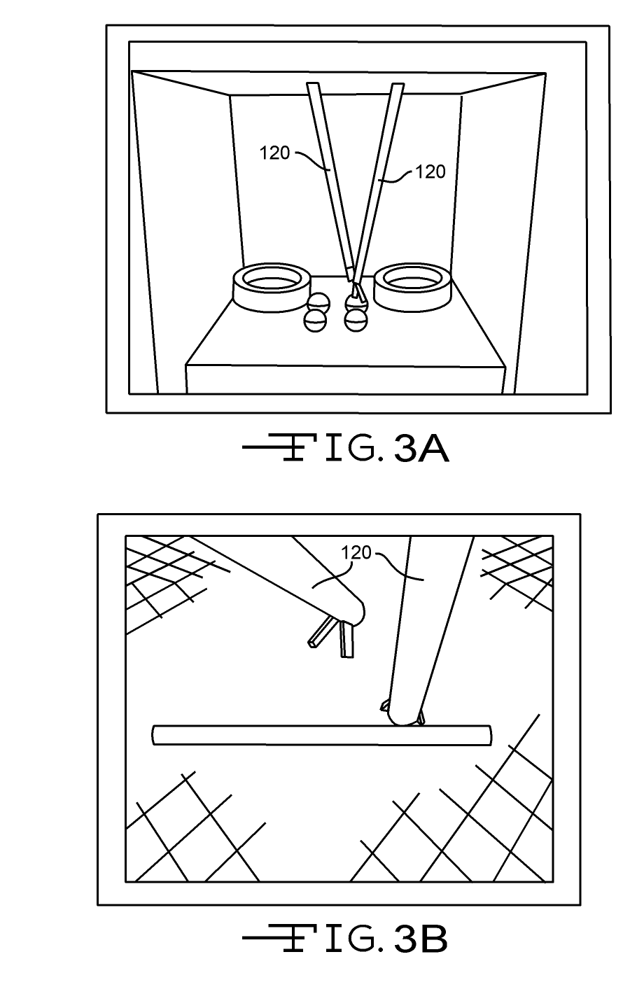

FIG. 4A depicts a line diagram of the dVSS master input device; FIG. 4B depicts a line diagram of the RoSS input device. The dVSS input device may be viewed as an arm and a wrist. The arm of the dVSS input device may have three degrees of freedom and comprise a shoulder and an elbow—the shoulder having two degrees of freedom, and the elbow having one degree of freedom. The five degrees of freedom of the wrist of the dVSS input device were collapsed and mapped to the three degrees of freedom of the RoSS input device. Due to the redundant degrees of freedom of the wrist of the dVSS, the 5 degrees of freedom could be collapsed to 3 degrees of freedom. The roll motion of the wrist of the master was mapped to the roll motion of the wrist of the RoSS. The yaw motion of the jaws of the wrist of the dVSS was mapped to the yaw motion of the end effector of the RoSS and the clasping of jaws was mapped to the clasping action of the pinch of the custom wrist of the RoSS input device.

In order to achieve the above mapping the DH parameters were calculated for dVSS master and RoSS input devices. It is a systematic notation for assigning orthonormal coordinate frames to the joints. The following steps are required in order to assign coordinate frames to the joints:
(1) Assign a coordinate frame L₀ to the dVSS base;
(2) Align zₖ with the axis of joint k+1;
(3) Locate the origin of Lₖ at the intersection of zₖ and zₖ₋₁. When there is no intersection, use the intersection of zₖ with a common normal between zₖ and zₖ₋₁;
(4) Select xₖ to be orthogonal to zₖ and zₖ₋₁. If zₖ and zₖ₋₁ are parallel, point xₖ away from zₖ₋₁; and
(5) Select yₖ to form a right handed orthonormal coordinate frame;

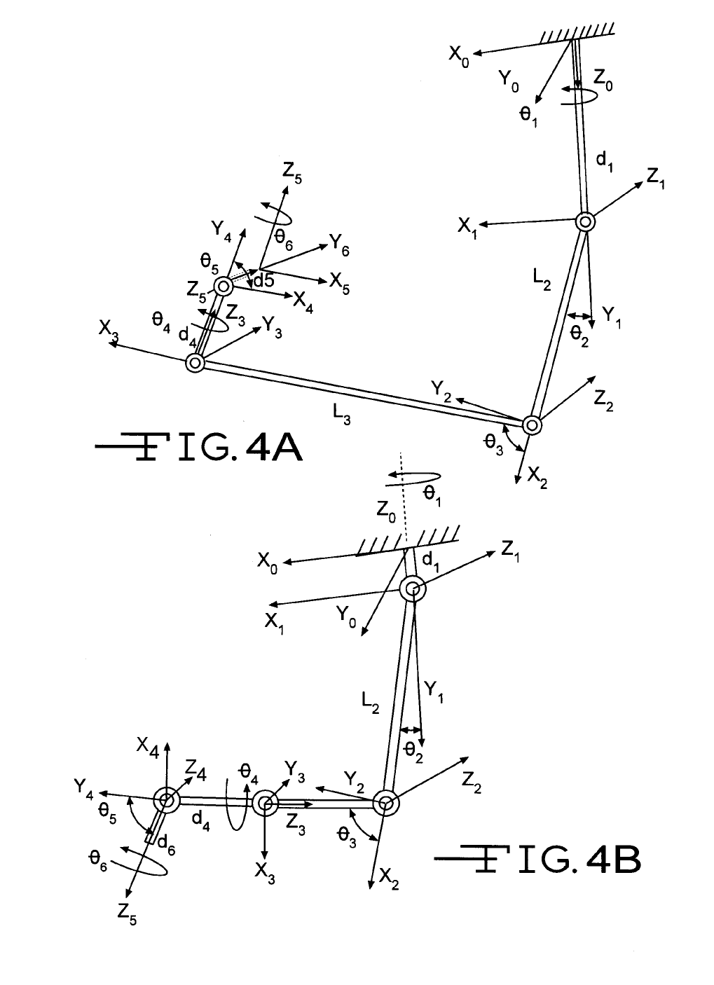

After assigning coordinate frames, the DH parameters may be calculated based on the following conventions (see FIGS. 5A and 5B):

(1) θₖ is the angle of rotation from xₖ₋₁ to xₖ measured about zₖ₋₁;

(2) dₖ is the distance measured along zₖ₋₁;

(3) aₖ is the distance measured along xₖ; and

(4) αₖ is the angle of rotation from zₖ₋₁ to zₖ about xₖ.

Each homogeneous transformation T may be represented as a product of four basic transformations associated with joints i and j (l-link length, α-link twist, d-link offset, and θ-joint angle) and I is a 4×4 identity matrix. The position and orientation of the end-effector is denoted by a position vector P and the 3×3 rotation matrix R. Based on the above DH parameters, a homogeneous transformation matrix is constructed which maps frame i coordinates into i-l coordinates as follows:

$$\begin{matrix}{T}_{i - 1}^{i} = [ \begin{matrix}cos {θ}_{i} & - sin {α}_{i} cos {θ}_{i} & sin {α}_{i} sin {θ}_{i} & {a}_{i} cos {θ}_{i} \\ sin {θ}_{i} & - cos {α}_{i} cos {θ}_{i} & sin {α}_{i} cos {θ}_{i} & {a}_{i} sin {θ}_{i} \\ 0 & sin {α}_{i} & cos {α}_{i} & {d}_{i} \\ 0 & 0 & 0 & 1\end{matrix} ] & ( 1 ) \\ {T}_{i - 1}^{i} = [ \begin{matrix} & R & & P \\ 0 & 0 & 0 & 1\end{matrix} ] & ( 2 )\end{matrix}$$

After calculating the homogeneous transformation matrix for each link, the composite transformation matrix is calculated. This matrix maps the tool coordinates to the base coordinates. This yields the transformation matrix as:

T_{base}^{tool}=T_{base}^{wrist}×T_{wrist}^{tool} (3)

This final composite transformation matrix is calculated with respect to the base frame. The DH parameters for the dVSS master are shown in Table 1.

TABLE 1
DH Parameters of dVSS master

| Link | Parameters | θ | d | a | α |
|---|---|---|---|---|---|
| 1 | θ1 | θ1 | d1 | 0 | −pi/2 |
| 2 | θ2 | θ2 | 0 | L2 | 0 |
| 3 | θ3 | θ3 | 0 | L3 | −pi/2 |
| 4 | θ4 | θ4 | d4 | 0 | pi/2 |
| 5 | θ5 | θ5 | d5 | 0 | −pi/2 |
| 6 | θ6 | θ6 | d6 | 0 | pi/2 |

The DH parameters for the RoSS console are shown in Table 2.

TABLE 2
DH Parameters of RoSS Console

| Link | Parameters | θ | d | a | α |
|---|---|---|---|---|---|
| 1 | θ1 | θ1 | d1 | 0 | −pi/2 |
| 2 | θ2 | θ2 | 0 | L2 | 0 |
| 3 | θ3 | θ3 | 0 | 0 | −pi/2 |
| 4 | θ4 | θ4 | d4 | 0 | pi/2 |
| 5 | θ5 | θ5 | 0 | 0 | −pi/2 |
| 6 | θ6 | θ6 | d6 | 0 | pi/2 |

Based on these DH parameters, the individual transformation matrix for each link may be calculated and the composite transformation matrix may be constructed after multiplying each of the individual transformation matrices as follows

T₀⁶=T₀¹×T₁²×T₂³×T₃⁴×T₄⁵×T₅⁶ (4)

To find the overall workspaces of the RoSS input device and dVSS input device, the range of angles of all the joints is found.

The range of each of the joint angles of RoSS input device is:

Joint 1: −1.45<θ₁<1.05 (radians)

Joint 2: 0.0<θ₂<1.727 (radians)

Joint 3: 1.0<θ₃<2.1 (radians)

Joint 4: 0.0<θ₄<4.71 (radians)

Joint 5: 0.0<θ₅<3.0 (radians)

Joint 6: 0.0<θ₆<4.71 (radians)

The range of each of the joint angles of dVSS input device is:

Joint 1: −0.53<θ₁<1.57 (radians)

Joint 2: 0.265<θ₂<0.785 (radians)

Joint 3: 0.0<θ₃<1.03 (radians)

Joint 4: −3.14<θ₄<1.57 (radians)

Joint 5: −1.57<θ₅<3.14 (radians)

Joint 6: −0.707<θ₆<0.707 (radians)

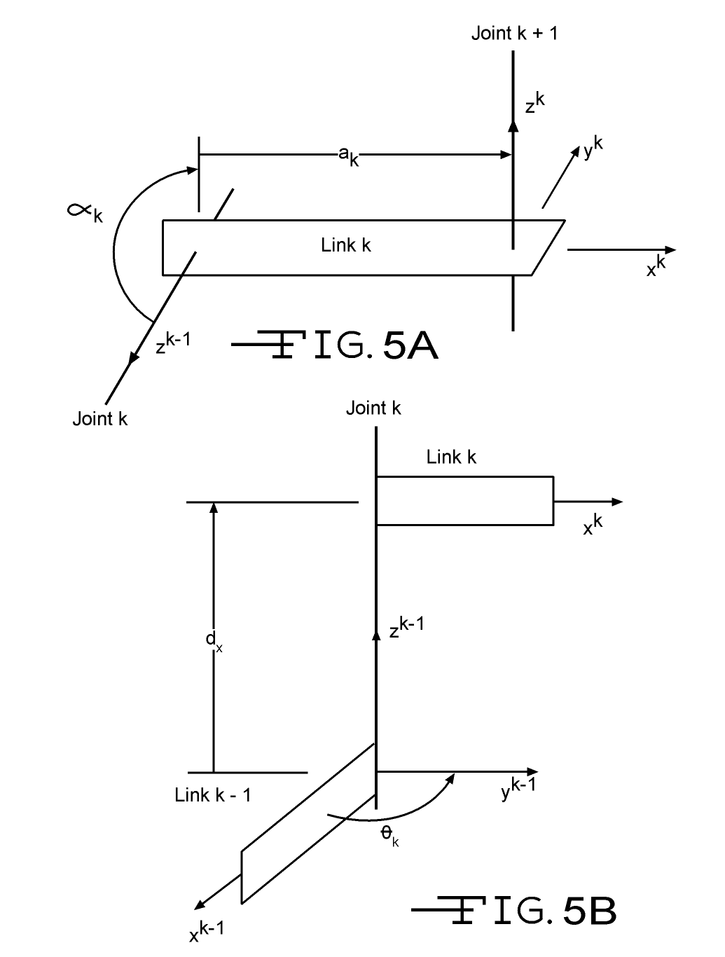

Each of the joint angles is varied incrementally to yield the end-effector positions in the workspace (FIGS. 6A and 6B). The end-effector position matrix is homogenized by adding a fourth column to the x, y and z columns. The workspace positions for both the RoSS and dVSS input devices are calculated. The 4×4 transformation matrix between the two workspaces is calculated by:

T=pinv(P_{O})*P_{M} (5)

where: P_{O} is the set of homogenized positions for RoSS input device; and
P_{M} is the set of homogenized positions for dVSS input device.

Since the end-effector encoder position values from the RoSS input device were spatially transformed to the calculated position values of RoSS input device from DH notation, these positions may either be transformed to the RoSS workspace or transformed to the dVSS master workspace. Therefore, a set of device positions consisting of a large number of 3D spatial position values (9261 in number) and the end effector positions are homogenized by adding a fourth column to x, y and z columns. Then the 4×4 transformation matrix was found between the two workspaces.

### Workspace Mapping of dVSS Master and dVSS Slave

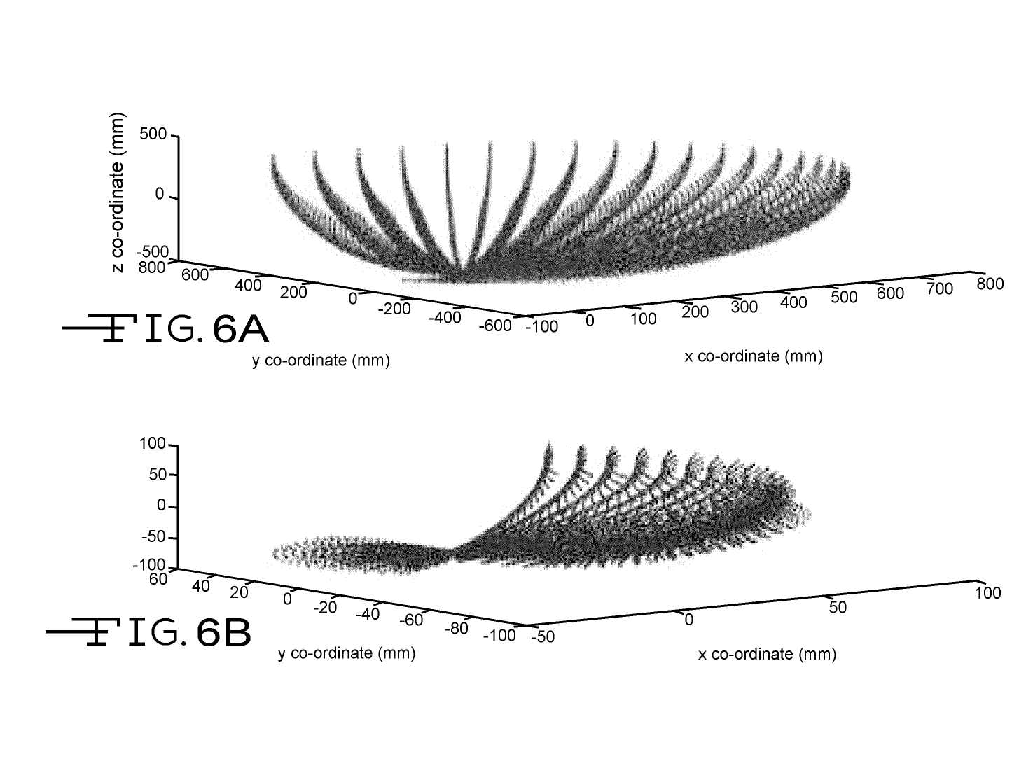

The master of the dVSS controls a highly articulated laparoscopic tool of dVSS shown in FIGS. 7A and 7B, the end-effector of which has seven degrees of freedom. In the RoSS master, the three degrees of freedom of the shoulder and elbow of the input devices were mapped such that the virtual surgical tool is pivoted about the site of entry and has two rotational degrees of freedom and one translational degree of freedom along its axis. Two of the three degrees of freedom of the wrist are mapped to the jaws to allow rotational movement of the virtual surgical tool and the clasping of the jaws was mapped to a clasping action of the pinch of the custom wrist. The virtual surgical tool has the same degrees of freedom as the tool which is used with the dVSS. In order to map the RoSS input device with the virtual surgical tool, the dVSS master was mapped to the dVSS slave.

Modified Denavit-Hartenberg (“DH”) notation is used to kinematically model the dVSS robot. The corresponding controlled parameters of the arm are summarized in Table 3. The kinematic equations of the arm for the instrument and the endoscope are represented by a total of 12 degrees of freedom (2 translational and 10 rotational).

TABLE 3
DH Parameters of dVSS Slave

| Link | Parameters | θ | d | a | α |
|---|---|---|---|---|---|
| 1 | t1 | 0 | t1 | L1 | 0 |
| 2 | θ2 | θ2 | H2 | 0 | 0 |
| 3 | θ3 | θ3 | H3 | L3 | 0 |
| 4 | θ4 | θ4 | H4 | L4 | 0 |
| 5 | θ5 | θ5 | H5 | L5 | −pi/2 |
| 6 | θ6 | θ6 | 0 | L6 | pi/2 |
| 7 | θ7 | θ7 | H7 | 0 | −pi/2 |
| 8 | θ8 | θ8 | H8 | L8 | 0 |
| 9 | t9 | 0 | t9 | L9 | 0 |
| 10 | θ10 | θ10 | 0 | 0 | 0 |
| 11 | θ11 | θ11 | L11 | 0 | −pi/2 |
| 12 | θ12 | θ12 | 0 | L12 | pi/2 |

The corresponding transformation matrices between links 1 to 6, links 7 to 9, and links 10 to 12 are T₀⁶, T₇⁹ and T₁₀¹². Links 1 to 6 correspond to the robot base, links 7 to 9 to the robot mechanism, and links 10 to 12 to the instruments. The robot base includes five revolute joints and one prismatic joint. A double parallelogram linkage mechanism is formed on link 8. The robot arm of the mechanism has three degrees of freedom, with two revolute joints and a prismatic joint.

Based on these DH parameters, the individual transformation matrix for each link is calculated as described above and the composite transformation matrix between the robot base and the end-effector of the robot (instrument) is constructed after multiplying each of the individual transformation matrices as follows

T₀¹²=T₀¹×T₁²×T₂³×T₃⁴×T₄⁵×T₅⁶×T₆⁷×T₇⁸×T₈⁹×T₉¹⁰×T₁₀¹¹×T₁₁¹² (6)

TABLE 4
DH Parameters of dVSS Master

| Link | Parameters | θ | d | a | α |
|---|---|---|---|---|---|
| 1 | θ1 | θ1 | d1 | 0 | −pi/2 |
| 2 | θ2 | θ2 | 0 | L2 | 0 |
| 3 | θ3 | θ3 | 0 | L3 | −pi/2 |
| 4 | θ4 | θ4 | d4 | 0 | pi/2 |
| 5 | θ5 | θ5 | 0 | L5 | −pi/2 |
| 6 | θ6 | θ6 | d6 | 0 | pi/2 |

The first six degrees of freedom of dVSS slave are initially set to a particular configuration. The next three degrees of freedom of dVSS slave (two revolute and one prismatic joint) are mapped to first three degrees of freedom (three revolute joints) of the robotic arms of the dVSS master console. The last three degrees of freedom of dVSS slave and dVSS master console are also set to a particular configuration.

To find the overall workspaces of dVSS master and dVSS slave, the range of joint angles of all the robot links was found. The range of each of the joint angles of dVSS slave is as follows:

Joint 1: t₁=9.0 (inches)

Joint 2: θ₂=0.0 (radians)

Joint 3: θ₃=0.0 (radians)

Joint 4: θ₄=0 (radians)

Joint 5: θ₅=1.05 (radians)

Joint 6: θ₆=1.05 (radians)

Joint 7: −1.57<θ₇<1.57 (radians)

Joint 8: −1.05<θ₈<1.05 (radians)

Joint 9: 0.0<t₉<9.0 (inches)

Joint 10: 0.0<θ₁₀<7.33 (radians)

Joint 11: 0.0<θ₁₁<3.14 (radians)

Joint 12: 0.0<θ₁₂<3.14 (radians)

The range of each of the joint angles of dVSS master is:

Joint 1: −0.53<θ₁<1.57 (radians)

Joint 2: 0.265<θ₂<0.785 (radians)

Joint 3: 0.0<θ₃<1.03 (radians)

Joint 4: −3.14<θ₄<1.57 (radians)

Joint 5: −1.57<θ₅<3.14 (radians)

Joint 6: −0.707<θ₆<0.707 (radians)

Each of the joint angles is varied incrementally to yield the end-effector positions in the workspace. Then the end-effector positions are homogenized by adding a fourth column to x, y and z columns. The workspace positions for both the dVSS master (FIG. 6A) and dVSS slave (FIG. 6C) was calculated. The 4×4 transformation matrix between the two workspaces is calculated by

T=pinv(P_{M})*P_{S} (7)

where: P_{S} is the set of homogenized positions for dVSS slave; and
P_{M} is the set of homogenized positions for dVSS master.

### Inverse Kinematics Using Jacobian-Based Control

Inverse kinematics may be used to find a set of joint configurations of an articulated structure based upon a desirable end-effector location. Inverse kinematics was used to determine a set of joint angles in an articulated structure based upon the position of the end-effector of the robot. This results in multiple joint angle solutions and infinite solutions at singularities. It may be generally used in software to control the joints. Control software should be able to perform the necessary calculations in near real time.

The mathematical representation of the inverse kinematics technique is defined as

θ=f⁻¹(X) (8)

Inverse kinematics may be implemented based upon the Jacobian technique. This technique incrementally changes joint orientations from a stable starting position towards a joint configuration that will result in the end-effector being located at the desired position in absolute space. The amount of incremental change on each iteration is defined by the relationship between the partial derivatives of the joint angles, θ, and the difference between the current location of the end-effector, X, and the desired position, X_{d}. The link between these two sets of parameters leads to the system Jacobian, J. This is a matrix that has dimensionality (m×n) where m is the spatial dimensional of X and n is the size of the joint orientation set, q.

X=f(θ) (9)

The Jacobian is derived from Equation 9 as follows. Taking partial derivatives of Equation 9:

dX=J(θ)dθ (10)

Where:

$${J}_{ij} = \frac{\partial {f}_{i}}{\partial {θ}_{j}} \qquad ( 11 )$$

Rewriting Equation 10 in a form similar to inverse kinematics (Equation 9), results in Equation 12. This form of the problem transforms the under-defined system into a linear one that can be solved using iterative steps.

dθ=J⁻¹dX (12)

The problem now is that Equation 12 requires the inversion of the Jacobian matrix. However because of the under-defined problem that the inverse kinematics technique suffers from, the Jacobian is very rarely square. Therefore, the right-hand generalized pseudo-inverse may be used to overcome the non-square matrix problem, as given in equation 14.

Generating the pseudo-inverse of the Jacobian in this way can lead to inaccuracies in the resulting inverse that need to be reduced. Any inaccuracies of the inverse Jacobian can be detected by multiplying it with the original Jacobian then subtracting the result from the identity matrix. A magnitude error can be determined by taking the second norm of the resulting matrix multiplied by dP, as outlined in Equation 15. If the error proves too big then dP can be decreased until the error falls within an acceptable limit.

An overview of the algorithm used to implement an iterative inverse kinematics solution is as follows:
(1) Calculate the difference between the goal position and the actual position of the end-effector.

dP=X_{g}−Xₚ (13)
(2) Calculate the Jacobian matrix using the current joint angles.

$${J}_{ij} = \frac{\partial {P}_{i}}{\partial {θ}_{j}} \qquad ( 14 )$$

(3) Calculate the pseudo-inverse of the Jacobian.

J⁻¹=J^{T}(JJ^{T})⁻¹ (15)
(4) Determine the error of the pseudo-inverse error:

error=∥I−(JJ⁻¹)dP∥ (16)
(5) If error>e then dP=dP/2 restart at step (4)
(6) Calculate the updated values for the joint orientations and use these as the new current values. Check the bounds for theta values.

$$θ = \{ \begin{matrix}lowerbound if θ + {J}^{- 1} dP < lowerbound \\ upperbound if θ + {J}^{- 1} dP > upperbound \\ θ + {J}^{- 1} dP if otherwise\end{matrix} \qquad ( 17 )$$

(7) Using forward kinematics determine whether the new joint orientations position the end-effector close enough to the desired absolute location. If the solution is adequate then terminate the algorithm otherwise go back to step (1).

The time to complete the Inverse Kinematics algorithm for a given end-effector is an unknown quantity due to an arbitrary number of iterations required. However, the time to complete a single iteration is constant with respect to the dimensionality of X and θ which is unchanged under a complete execution of the algorithm. Therefore by placing an upper limit on the number of iterations we can set a maximum time boundary for the algorithm to return in. If the solver reaches the limit then the algorithm returns the closest result it has seen.

### Jacobian-Based Inverse Kinematics Applied to Simulation

The dVSS slave consists of 12 degrees of freedom and the inverse kinematics were used to control only the three degrees of freedom. The first six degrees of freedom were fixed to suitable joint angles. These joint angles were calculated on the basis of a particular dVSS configuration during a surgical procedure in the operating room. The next three degrees of freedom are being considered for inverse kinematics control. These were two revolute joints and one prismatic joint. The last three degrees of freedom were also constrained as part of wrist at a particular configuration. (pi/2, pi/2, 0 radians).

The algorithm requires it to initialize the three joint angles which correspond to a particular configuration of dVSS. Then using forward kinematics, the end-effector position of the dVSS surgical tool (slave) is found which correspond to the initial position of the slave. Once the initial position is found the difference between the goal and initial position is calculated. The Jacobian is calculated by differentiating the end-effector position with respect to the three slave joint angles (two revolute joints and one prismatic joint) using the following equation:

$$J = [ \begin{matrix}\frac{d Px}{d {θ}_{7}} & \frac{d Px}{d {θ}_{8}} & \frac{d Px}{d {t}_{9}} \\ \frac{d Py}{d {θ}_{7}} & \frac{d Py}{d {θ}_{8}} & \frac{d Py}{d {t}_{9}} \\ \frac{d Pz}{d {θ}_{7}} & \frac{d Pz}{d {θ}_{8}} & \frac{d Pz}{d {t}_{9}}\end{matrix} ] \qquad ( 18 )$$

Once the Jacobian is known, its pseudo inverse is calculated. The pseudo inverse was used to reduce the singularities in the matrix. Then the three joint angles are updated using the following equation:

$$[ \begin{matrix}{θ}_{7} \\ {θ}_{8} \\ {θ}_{9}\end{matrix} ] = \{ \begin{matrix}lowerbound if [ \begin{matrix}{θ}_{7} \\ {θ}_{8} \\ {t}_{9}\end{matrix} ] + {J}^{- 1} [ \begin{matrix}{dP}_{x} \\ {dP}_{y} \\ {dP}_{z}\end{matrix} ] < lowerbound \\ upperbound if [ \begin{matrix}{θ}_{7} \\ {θ}_{8} \\ {t}_{9}\end{matrix} ] + {J}^{- 1} [ \begin{matrix}{dP}_{x} \\ {dP}_{y} \\ {dP}_{z}\end{matrix} ] > upperbound \\ [ \begin{matrix}{θ}_{7} \\ {θ}_{8} \\ {t}_{9}\end{matrix} ] + {J}^{- 1} [ \begin{matrix}{dP}_{x} \\ {dP}_{y} \\ {dP}_{z}\end{matrix} ] if otherwise\end{matrix} \qquad ( 19 )$$

Using forward kinematics equations, the three joint orientations are used to calculate the end-effector position and the difference between the goal position and the current end-effector position is checked. If the two are close enough then the algorithm is terminated.

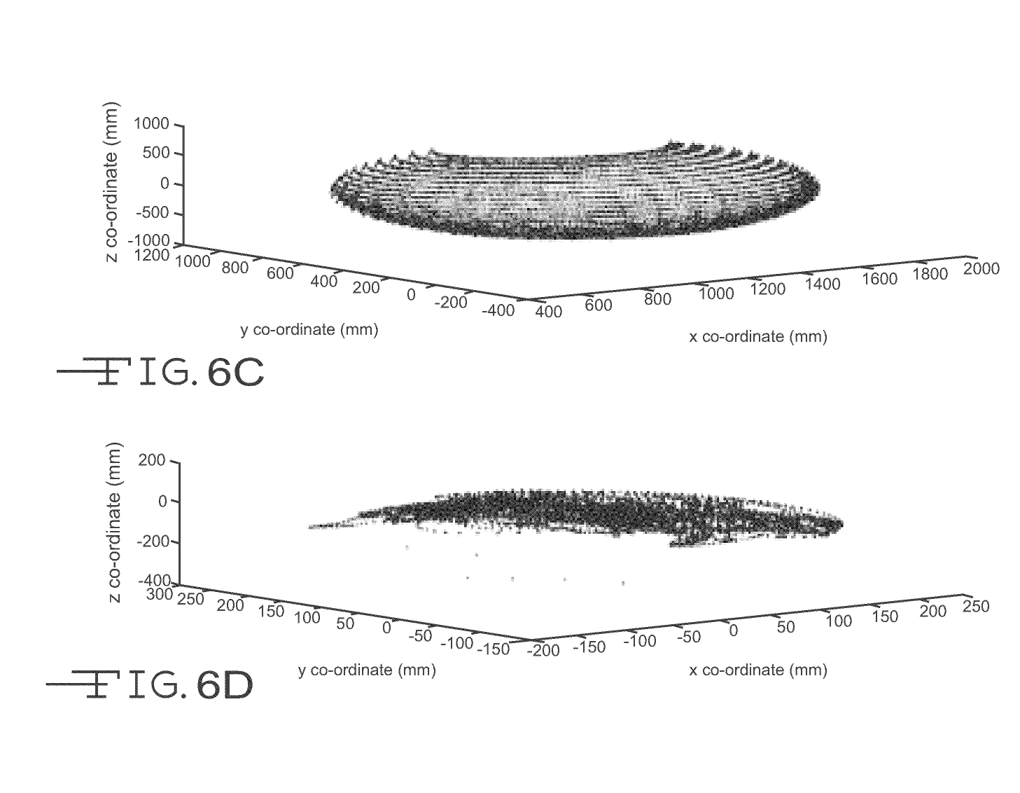

FIGS. 8A and 8B shows a complete cycle of an inverse kinematics algorithm for a particular RoSS input device position. The initial input device position was [−24.7935, −47.8608, −47.7267] mm and when it was transformed to the dVSS slave position which was the goal position. The initial dVSS slave position was calculated using the initial joint configuration of the dVSS slave (using DH notation) where the joint values of the 7^{th}, 8^{th}, and 9^{th} joint are taken as −pi/6 radians, pi/4 radians, and 1 inch respectively. The algorithm took 8 iterations and the intermediate joint configuration and position values are shown in FIGS. 8A and 8B.

The motions of the virtual tool of dVSS were performed using inverse kinematics which was essentially controlled by RoSS console. The Omni device positions were transformed to the positions of virtual tool of dVSS and then the inverse kinematics was performed to calculate the link parameters (joint angles) of the virtual tool.

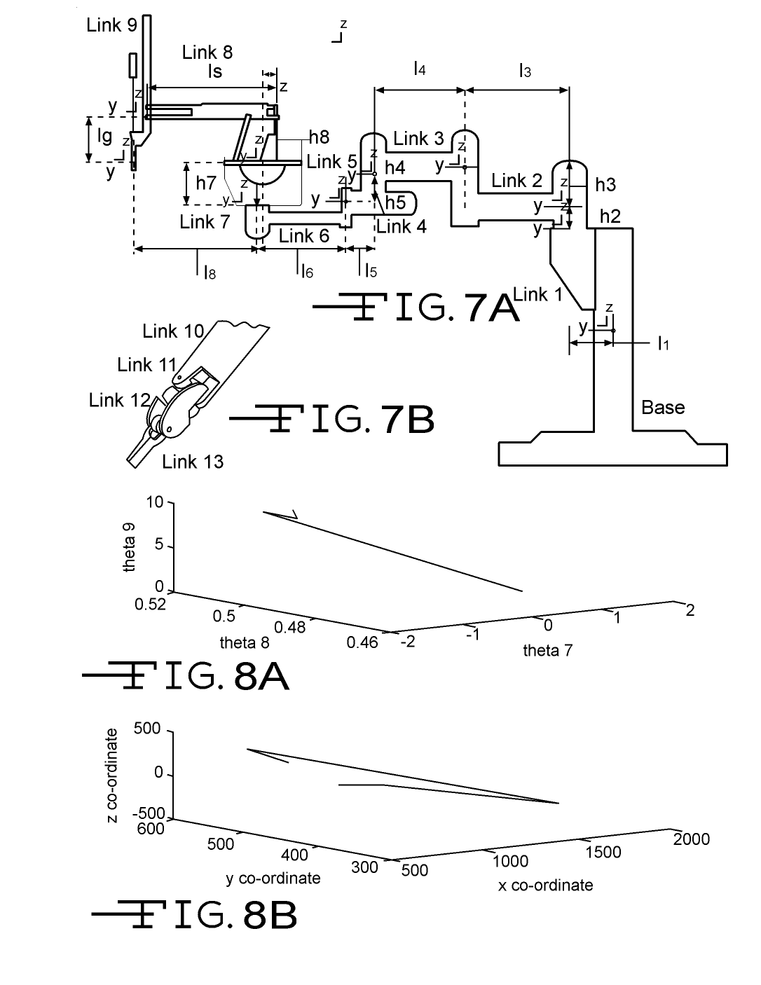

FIG. 9 is a graph of RoSS input device positions. The positions are homogenized. The transformation matrix between the RoSS input device positions and dVSS master workspace is calculated by taking the pseudo inverse of device positions and multiplying by dVSS master homogeneous positions using Equation 5 (as described above).

Similarly the transformation matrix between dVSS master and dVSS slave was obtained as described above.

The transformation matrix between the RoSS console workspace and dVSS slave workspace is found by multiplying the two transformation matrices. FIG. 6C depicts the workspace mapping of the dVSS slave and FIG. 6D depict the workspace mapping of the RoSS console (using device positions).

Once the transformation matrix is obtained, the RoSS input device position is transformed to the dVSS slave position. After the dVSS slave position is obtained, the inverse kinematics is performed to get the joint angles of 7^{th}, 8^{th} and 9^{th} links as described above. The 7^{th} and 8^{th} links are revolute joints and 9^{th} link is a prismatic joint. The accuracy of the algorithm is 10⁻⁵ mm and the computational time is 25-35 ms for computing each of the three sets of joint angles using inverse kinematics algorithm. The number of iterations is set to be 40 for a single run of algorithm. The motion of the virtual tool was manipulated to get the desired motion of dVSS slave.

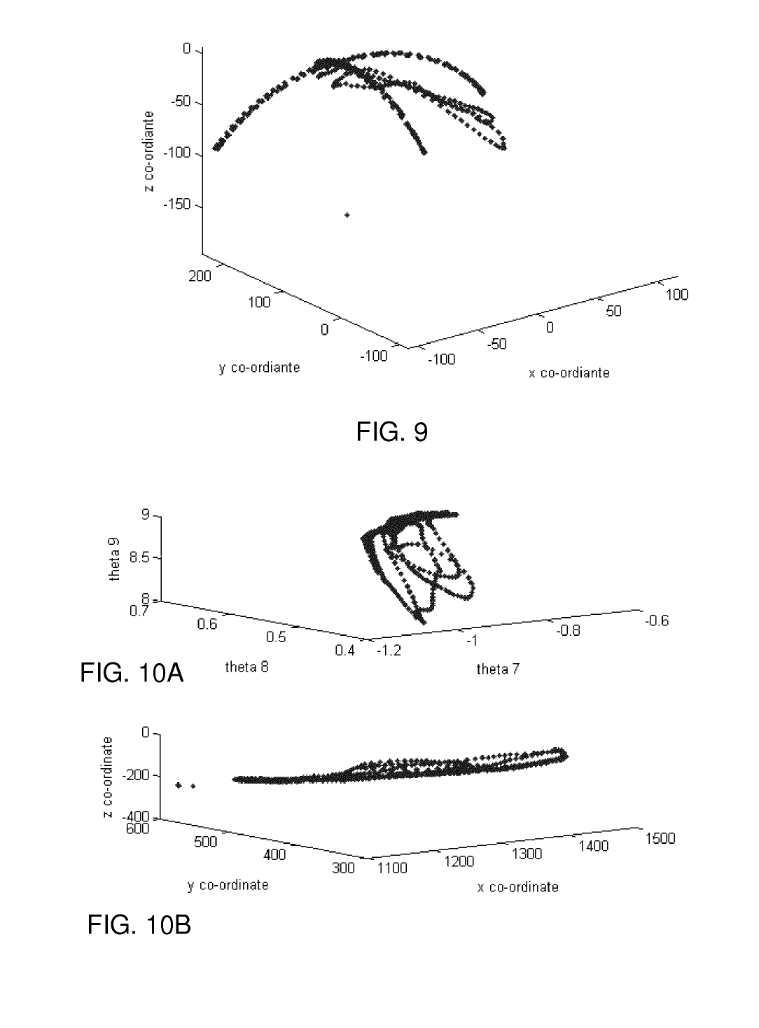

FIG. 10A shows joint configurations of the RoSS, and FIG. 10B shows the workspace of the RoSS using inverse kinematics for a set of input device positions.

The bounds on the 7^{th}, 8^{th} and 9^{th} Joint Configurations for the dVSS slave using inverse kinematics algorithm were found to be:

Joint 7: −1.15<θ₇<−0.75 (radians)
Joint 8: 0.35<θ₈<0.60 (radians)
Joint 9: 7.5<t₉<9.0 (inches)

These joint values were used to calculate the end-effector boundaries of dVSS slave. The dVSS slave was treated as a six degrees of freedom robot (3 degrees of freedom for arm and 3 degrees of freedom for wrist) so that the axis orientations of the dVSS slave and the RoSS input device are coincident.

The workspace boundaries of the dVSS slave from the above joint range using DH notation was found to be:

170<x<370 mm
−450<y<−250 mm
−120<z<−5 mm

The workspace boundaries of end-effector of the RoSS input device position are:

−108<x<117 mm
−110<y<240 mm
−200<z<−10 mm

Since the axis orientations of the dVSS slave and the RoSS input device are the same, the x, y, z axes of RoSS input device were mapped onto the x, y, z axes of dVSS slave. Then the two rotations along x and z axes and one translation along y axis were calculated to give the actual dVSS slave motions.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A surgical robot simulation system comprising:
a frame;
a computer;
a display in communication with the computer;
two input devices in communication with the computer, each input device having a base, an arm, and an end-effector, wherein the arms comprise a plurality of joints, the input devices being attached to the frame so that a first joint of each arm resides beneath the base, and wherein each of the input devices provides a position signal to the computer, the positional signal corresponding to a position of the arm of the input device; and
wherein the computer is programmed to:
accept a position signal from each of the input devices; and
transform each of the position signals into a position of a virtual surgical tool depicted on the display.

2. The surgical robot simulation system of claim 1 wherein the computer is further programmed to:
use a mathematical transform function to alter a relationship between movement of the arm in real space and movement of the virtual surgical tool in virtual space.

3. The surgical robot simulation system of claim 2 wherein the mathematical transform function causes the relationship of arm and virtual surgical tool movements to substantially mimic the relationship of a position of a control to a position of a surgical tool in a surgical robot.

4. The surgical robot simulation system of claim 3 wherein the surgical robot is a da Vinci® surgical system.

5. The surgical robot simulation system of claim 1 wherein the display is a touchscreen.

6. The surgical robot simulation system of claim 1 further comprising a foot-operable input.

7. The surgical robot simulation system of claim 1 wherein the frame is adjustable.

8. The surgical robot simulation system of claim 7 wherein the frame may fold into a substantially flat shape.

9. The surgical robot simulation system of claim 1 wherein the display is a binocular display capable of displaying a stereoscopic image.

10. The surgical robot simulation system of claim 1 wherein each input device provides at least six degrees of freedom.

11. A method for simulating the kinematics of a robotic surgery system comprising the steps of:
providing a robot simulation system comprising:
a computer;
a display in communication with the computer; and
an input device in communication with the computer, the input device having a input device workspace defined by the range of motion of the input device;
providing a robotic surgery system comprising:
a master console having a manipulator, the manipulator having a manipulator workspace defined by the range of motion of the manipulator; and
a slave robot having a slave robot workspace defined by the range of motion of the slave robot;
determining a first 4×4 transformation matrix between the input device workspace and the manipulator workspace;
determining a second 4×4 transformation matrix between the manipulator workspace and the slave robot workspace;
determining a simulation transformation matrix between the input device workspace and the slave robot matrix by multiplying the first and the second 4×4 transformation matrices; and
using the simulation transformation matrix to cause a virtual surgical tool depicted on the display to respond to a positional change in the input device which substantially simulates a response of the slave robot to a positional change in the manipulator.
